(19) United States
(12) Patent Application Publication
(10) Pub. No.: US 2016/0266655 A1
(43) Pub. Date: Sep. 15, 2016

(54) METHOD FOR ACTIVATING AN ACTUATOR OF A MOTOR VEHICLE, DEVICE CONFIGURED TO CARRY OUT THE METHOD, AND COMPUTER PROGRAM PRODUCT

(71) Applicant: Robert Bosh GmbH, Stuttgart (DE)

(72) Inventor: Andreas Heyl, Palo Alto, CA (US)

(21) Appl. No.: 15/055,017

(22) Filed: Feb. 26, 2016

(30) Foreign Application Priority Data
Mar. 10, 2015 (DE) 102015204280.4

(51) Int. Cl. G06F 3/01; B60Q 5/00; G06F 3/00; B60Q 1/04

(52) U.S. Cl. CPC G06F 3/017; B60Q 1/04; B60Q 5/00; G06F 3/005

(57) ABSTRACT

A method for activating an actuator of a motor vehicle, a device configured to carry out the method, and a computer program product. The method includes the detection of a gesture with the aid of a gesture-sensitive device and the activation of the actuator in response to the detected gesture. The actuator is activated only when the detected gesture is being validated. This has the advantage that erroneously recognized gestures are prevented from resulting in false activations of actuators.

### CROSS REFERENCE

The present application claims the benefit under 35 U.S.C. §119 OF German Patent Application No. 102015204280.4 filed on Mar. 10, 2015, which is expressly incorporated herein by reference in its entirety.

### FIELD

The present invention relates to a method for activating an actuator of a motor vehicle, a device configured to carry out the method, and a computer program product.

### BACKGROUND INFORMATION

Motor vehicles are equipped with a plurality of actuators. Exemplary actuators are headlights, blinkers (turn signals), rear and front fog lights, the horn, windshield wipers, and door locks. Actuators may be activated with the aid of levers, control dials, switches, and pushbuttons.

Body computers in motor vehicles control and monitor the associated components and their functions. For example, SDRAM modules and a CPU are situated on the motherboards of the head unit of a motor vehicle. Additionally, there are chips for the digital signal processing (DSP) or field programmable gate arrays (FPGAs), for example for audio processing, MP3 decoding and graphics calculation for 2D effects. A GPS receiver is often installed for the navigation. The speedometer and other components may be connected via the CAN bus; further audio components may be reached via a MOST bus, for example.

The body computer and/or the head unit detect(s) that the lever, control dial, switch and pushbutton was adjusted and/or switched and activates the actuator in response thereto.

This activation may take place with the aid of gestures. One example of gesture control is the Land Rover Discovery Vision Concept which was introduced at the 2014 New York Auto Show. This Land Rover may be opened and operated with the aid of gesture control.

Gesture recognition is possible in a variety of ways.

Chirp, for example, is a gesture detection system which functions similarly to bat echolocation. Ultrasonic sources emit a signal. If it impinges on an object, for example a hand, it is reflected. These echoes are picked up, and the time which has lapsed until then is recorded. Different gestures may be recognized based on different propagation times.

German Patent Application No. DE 10 2011 087 347 describes a method for controlling at least one actuator based on signal propagation time changes of at least one ultrasonic sensor. A closing element of a tailgate, of an engine hood, of a door, of a sliding sunroof and/or hydraulic elements is/are activated as actuators, for example.

Cameras, in particular but not only stereo cameras, offer another option for gesture detection.

German Patent Application No. DE 10 2005 019 154 describes a device for setting at least one motor vehicle component as a function of a signal of an imaging sensor system in a motor vehicle. The device is configured in such a way that the device begins, suppresses or ends the setting as a function of at least one gesture of a motor vehicle occupant which is recognized by the imaging sensor system.

### SUMMARY

In accordance with the present invention, an example method is provided which includes the detection of a gesture with the aid of a gesture-sensitive device and the activation of the actuator in response to the detected gesture. The actuator is activated only if the detected gesture is being validated.

This has the advantage that erroneously recognized gestures are prevented from resulting in erroneous activations of actuators.

In one preferred specific embodiment, a voice command assigned to the gesture is detected, and the detected gesture is validated by the voice command.

Voice validation is particularly easy for the driver and therefore advantageous.

In addition or as an alternative, the detected gesture may be validated by a measurement of a turning angle of a steering wheel of the motor vehicle, a comparison to a planned route of a navigation system, a detection of a further gesture and/or of an acoustic confirmation, and/or an approval input on the gesture-sensitive device.

These forms of validation require particularly little driver interaction.

The gesture-sensitive device may be a smart watch, and the gesture may include a movement and/or a rotation of an arm to which the smart watch is attached. Accelerometers and/or gyroscopes in the wristband of the and/or in the smart watch may be used to detect arm movements/rotations. Alternatively, the gesture-sensitive device may be smart glasses. One or more cameras and/or accelerometers and/or gyroscopes in the smart glasses may be used to detect head movements/rotations.

Or the camera may be part of the motor vehicle. The gesture recognition may then take place by image recognition.

The smart watch or the smart glasses allow(s) particularly reliable gesture recognition since the smart watch is connected to the arm, and the smart glasses are connected to the head, which is used to carry out the gesture.

A rotating direction during the rotation of the arm may be detected, and the actuator may be activated in two different ways, the manner in which the actuator is activated being determined based on the detected rotating direction.

In this way, differentiated activations of actuators may be implemented.

The motor vehicle may include a main control unit or a body computer. The detected gesture may then be transmitted to the main control unit or the body computer, and the actuator may be activated by the main control unit or the body computer.

This makes it possible in a particularly simple manner to upgrade existing systems, in which actuators are activated by the main control unit or the body computer, according to the present invention.

The actuator may be deactivated by a different gesture, a different voice command and/or by actuating a mechanical device of the actuator.

The actuator may be a headlight, and the activation may involve turning on the high beam of the headlight. The actuator may be a fog light, and the activation may involve switching the fog light on or off. The actuator may be a horn, and the activation may involve triggering of the horn. The actuator may be a door lock, and the activation may involve closing or opening of the door lock. The actuator may be a trunk lock, and the activation may involve closing or opening of the trunk lock. The actuator may be a windshield wiper, and the activation may involve switching on a speed level of the windshield wiper or switching between the speed levels.

According to the present invention, a device for a motor vehicle is also provided. The device is configured to carry out the steps of the example method according to the present invention.

A device may be understood to mean an electrical device and/or a control device which processes sensor signals and outputs control signals as a function thereof.

Finally, according to the present invention a computer program product is also provided. The computer program product includes processor-executable program code for carrying out the example method according to the present invention if the program is executed on a processor.

Advantageous refinements of the present invention are described below.

### BRIEF DESCRIPTION OF THE DRAWING

Exemplary embodiments of the present invention are described in greater detail based on the FIGURE and the description below.

FIG. 1 shows a flow chart of one exemplary specific embodiment of the method according to the present invention.

### DETAILED DESCRIPTION OF EXAMPLE EMBODIMENTS

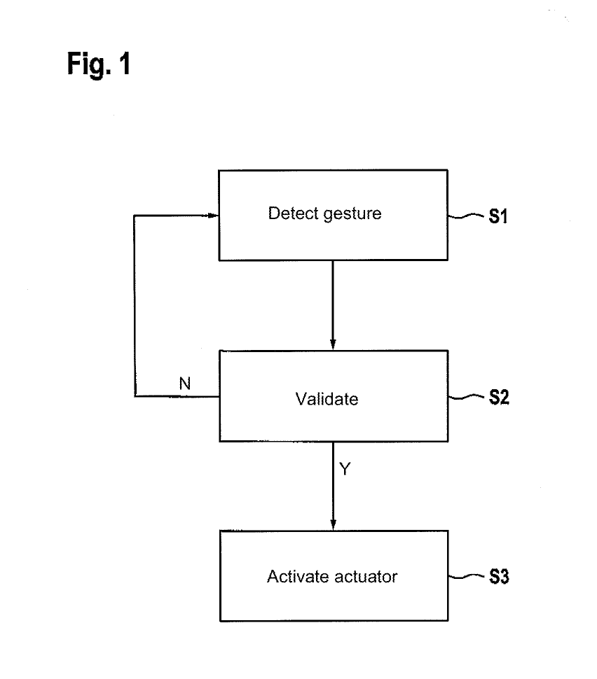

FIG. 1 shows a flow chart of one exemplary specific embodiment of the method according to the present invention for activating an actuator of a motor vehicle. The method includes as step S1 a detection of a gesture with the aid of a gesture-sensitive device. The gesture may be a head gesture, a finger gesture, a hand gesture or an arm gesture, for example. Exemplary gestures include vertical and horizontal movements and rotations, swinging, waving, wiping and nodding. A rotating and/or a moving direction may be used for this purpose to enable two activation forms of an actuator using two gestures which differ only in the rotating and/or moving direction. For example, a viewing direction may be indicated by the rotating direction.

The gesture-sensitive device may be a smart watch or smart glasses, for example, which is/are worn by a driver of a motor vehicle.

The driver may then operate actuators of the motor vehicle using the smart watch or smart glasses. It is also possible that the gesture-sensitive device includes a stationary camera or a camera which is integrated in the smart glasses and/or an ultrasonic sound-based system. Other gesture-sensitive devices are possible. For example, motion measuring instruments present in the smart watch or the smart glasses, such as gyroscopes and/or accelerometers, may be used for gesture detection. Camera images may be used alternatively or additionally to the gesture detection. The detection based on measuring signals of the motion measuring instruments may take place partially or completely in the smart glasses or in the smart watch. Partially processed data or the unprocessed raw data may be forwarded to the body computer of the motor vehicle, which then detects the gesture. This forwarding may take place wirelessly. The smart glasses or the smart watch may be calibrated with respect to their location in the motor vehicle prior to carrying out the method.

The detected gesture is validated in a subsequent step S2.

If the gesture is validated, subsequently step S3 is carried out, in which the actuator is activated, i.e., the turn signal is set, for example.

If the gesture is not validated, the method returns to step S1 without the actuator being activated.

The validation may take place based on an approval which was granted before the gesture was detected. The approval may be an approval of all or certain gestures, for example. Approved gestures may be validated across the board, i.e., the actuator is activated as soon as the gesture is detected. Or gestures are conditionally validated, i.e., when an approved gesture is detected, a subsequent validation is required to trigger the activation of the actuator. Other approval forms are possible.

The approval also makes it possible, among other things, that different actuators may be activated with the detection of one and the same gesture, and the gesture may be exclusively approved for an actuator to be determined.

The validation and/or approval may take place with the aid of a voice command. For example, the head unit or smart glasses may pick up the driver's speech, which is thereupon analyzed in the head unit, in the body computer or in the smart glasses as to whether a command was issued which is stored linked to the detected gesture. The voice command may be preceded by an acoustic prompt for the driver to vocalize the voice command. Another form of validation and/or approval may be another gesture which the driver carries out unsolicited or upon being prompted by the system. For example, a nodding may be detected with the aid of smart glasses and be used for the validation, either always or only when the nodding is detected after a voice prompt in order to validate a previously detected gestures.

In addition or as an alternative, the validation and/or approval may include a plausibility check of the detected gesture with respect to motor vehicle control and/or motor vehicle navigation information. For example, if a gesture is detected which corresponds to the activation of the blinker in one direction, and the steering wheel is turned in this direction, this may be used for a validation and/or an approval. In addition or as an alternative, the validation and/or approval may require that the route planned according to the navigation system provides for a turning in this direction now or in the near future. Generally or in case of doubt, the validation may be necessary to enable an activation of the actuator with the aid of a gesture.

The actuator (and the associated activation) may be, for example, a turn signal (blinking right/left and/or hazard flashes), a headlight (switching on and/or turning up and/or turning down), a rear fog light (turning on and/or off), a front fog light (turning on and/or off), a horn (triggering), a windshield wiper (switching on and/or off and/or changing the wiping speed) and/or a lock (opening/closing) of a motor vehicle door or of the trunk.

The gesture which must be detected for the actuator to be activated may be associated with the actuator and/or the activation. For example, a rotation of the wrist to the left after validation may activate the left turn signal, and a rotation of the wrist to the right after validation may activate the right turn signal. A wiping gesture may activate the windshield wiper. A speed of the wiping gesture may determine the wiping speed of the windshield wiper.

Although the present invention was illustrated and described in greater detail by preferred exemplary embodiments, the present invention is not limited by the described examples and other variations may be derived therefrom by those skilled in the art without departing from the scope of protection of the present invention.

What is claimed is:

1. A method for activating an actuator of a motor vehicle, the method including:
detecting a gesture with the aid of a gesture-sensitive device; and
activating the actuator in response to the detected gesture, the actuator being activated only if the detected gesture has been validated.

2. The method as recited in claim 1, wherein a voice command assigned to the gesture is detected, and the detected gesture is validated by the voice command.

3. The method as recited in claim 1, wherein the detected gesture is validated by at least one of: i) a measurement of a turning angle of a steering wheel of the motor vehicle, ii) a comparison to a planned route of a navigation system, iii) a detection of a further gesture or of an acoustic confirmation, and iv) an approval input on the gesture-sensitive device.

4. The method as recited in claim 1, wherein the gesture-sensitive device is a camera which is part of the motor vehicle.

5. The method as recited in claim 1, wherein the gesture-sensitive device is a camera which is part of smart glasses, and the gesture includes at least one of a movement of a head and a rotation of the head.

6. The method as recited in claim 1, wherein the gesture-sensitive device is a smart watch, and the gesture includes at least one of a movement and a rotation of an arm to which the smart watch is applied.

7. The method as recited in claim 6, wherein the gesture-sensitive device is a smart watch, a rotating direction during the rotation of the arm is detected, and the actuator may be activated in two different ways, the manner in which the actuator is activated being determined based on the detected rotating direction.

8. The method as recited in claim 1, wherein the motor vehicle includes a main control unit or a body computer, the detected gesture being transmitted to the main control unit or the body computer, and the actuator being activated by the main control unit or the body computer.

9. The method as recited in claim 1, wherein the actuator is deactivated by at least one of a different gesture, a different voice command, and actuating a mechanical device for deactivating the actuator.

10. The method as recited in claim 1, wherein one of:
the actuator is a headlight, and the activation involves turning on a high beam of the headlight;
the actuator is a fog light, and the activation involves switching the fog light on or off;
the actuator is a horn, and the activation involves triggering of the horn;
the actuator is a door lock, and the activation involves closing or opening of the door lock;
the actuator is a trunk lock, and the activation involves closing or opening of the trunk lock; or
the actuator is a windshield wiper, and the activation involves switching on a speed level of the windshield wiper or switching between the speed levels.

11. A device for a motor vehicle configured to:
detect a gesture with the aid of a gesture-sensitive device; and
activate the actuator in response to the detected gesture, the actuator being activated only if the detected gesture has been validated.

12. A computer program product, including processor-executable program code, the program code, when excited by a processor, causing the processor to perform:
detecting a gesture with the aid of a gesture-sensitive device; and
activating the actuator in response to the detected gesture, the actuator being activated only if the detected gesture has been validated.
